(19) United States
(12) Patent Application Publication
(10) Pub. No.: US 2018/0238400 A1
(43) Pub. Date: Aug. 23, 2018

(54) BALL COUPLING ASSEMBLY FOR STEERING COLUMN ASSEMBLY

(71) Applicant: STEERING SOLUTIONS IP HOLDING CORPORATION, Saginaw, MI (US)

(72) Inventors: Brian J. Magnus, Frankenmuth, MI (US); John S. Beam, Freeland, MI (US)

(21) Appl. No.: 15/438,109

(22) Filed: Feb. 21, 2017

(51) Int. Cl. F16D 15/00; B62D 1/16; F16D 28/00

(52) U.S. Cl. CPC F16D 15/00; B62D 6/00; F16D 28/00; B62D 1/16

(57) ABSTRACT

A steering column assembly for an autonomous or semi-autonomous vehicle includes a steering wheel and an upper steering shaft rigidly coupled to the steering wheel. Also included is a lower steering shaft operatively coupled to the upper steering shaft. Further included is a ball coupling assembly comprising balls retained within the upper steering shaft, the balls disposed in a first radial position that engages the balls with the upper steering shaft and the lower steering shaft to place the steering shafts in a coupled condition, the balls disposed in a second radial position that disengages the balls from at least one of the upper steering shaft and the lower steering shaft to place the steering shafts in a decoupled condition.

### BACKGROUND OF THE INVENTION

The invention described herein relates to steering column assemblies and, more particularly, to a ball coupling assembly for steering column assemblies implemented in autonomous or semi-autonomous vehicles.

As the automotive industry moves toward autonomously driven vehicles, there will be Advanced Driver Assist Systems (ADAS) that allow a vehicle to be autonomously controlled using sensing, steering, and braking technology.

Implementing steering on ADAS vehicles may include decoupling the driver interface (e.g., steering wheel) from the steering actuator. However, a rotating driver interface may cause confusion, inconvenience or even harm to the driver during an autonomous driving mode. Addressing the issue of a moving interface will assist with the overall development of autonomous vehicle technology and feasibility.

### SUMMARY OF THE INVENTION

According to an aspect of the invention, a steering column assembly for an autonomous or semi-autonomous vehicle includes a steering wheel. Also included is an upper column steering shaft rigidly coupled to the steering wheel. Further included is a lower column steering shaft operatively coupled to the upper column steering shaft. Yet further included is a ball coupling assembly for switching the upper column steering shaft and the lower column steering shaft between a coupled condition and a decoupled condition. The ball coupling assembly includes a plurality of balls retained within the upper column steering shaft. The ball coupling assembly also includes a plurality of pockets circumferentially spaced from each other and defined by the lower steering shaft, each of the pockets sized to receive a portion of one of the plurality of balls. The ball coupling assembly further includes a collar surrounding the balls, the collar having an angled portion of an inner wall disposed in contact with the balls. The ball coupling assembly yet further includes a collar actuating mechanism for selectively axially translating the collar between a coupled condition and a decoupled condition.

According to another aspect of the invention, a steering column assembly for an autonomous or semi-autonomous vehicle includes a steering wheel. Also included is an upper column steering shaft rigidly coupled to the steering wheel. Further included is a lower column steering shaft operatively coupled to the upper column steering shaft. Yet further included is a ball coupling assembly for switching the upper column steering shaft and the lower column steering shaft between a coupled condition and a decoupled condition. The ball coupling assembly includes a plurality of balls retained within respective holes defined by the lower column steering shaft in a single axial plane. The ball coupling assembly also includes a central pin disposed within a bore of the lower column steering shaft and axially translatable therein. The ball coupling assembly further includes an annular recess defined by the central pin. The ball coupling assembly yet further includes a central pin actuating mechanism for axially translating the central pin, the balls disposed at a first radial position that disposes the balls within the annular recess to place the upper and lower column steering shafts in a decoupled condition, the balls disposed at a second radial position that disposes the balls in abutment with a radially outer surface of the central pin and within the holes of the lower column steering shaft and holes of the upper column steering shaft to place the upper and lower column steering shafts in a coupled condition, the coupled condition providing common rotation of the upper and lower column steering shafts and the decoupled condition permitting independent rotation of the upper and lower column steering shafts.

According to yet another aspect of the invention, a steering column assembly for an autonomous or semi-autonomous vehicle includes a steering wheel. Also included is an upper column steering shaft rigidly coupled to the steering wheel. Further included is a lower column steering shaft operatively coupled to the upper column steering shaft. Yet further included is a ball coupling assembly comprising a plurality of balls retained within the upper column steering shaft, the balls disposed in a first radial position that engages the balls with the upper column steering shaft and the lower column steering shaft to place the upper and lower column steering shafts in a coupled condition, the balls disposed in a second radial position that disengages the balls from at least one of the upper column steering shaft and the lower column steering shaft to place the upper and lower column steering shafts in a decoupled condition.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of a steering column assembly in a coupled condition according to an aspect of the disclosure;

FIG. 2 is a partial cross-sectional view of the steering column assembly of FIG. 1 in a decoupled condition;

FIG. 3 is a partial cross-sectional view of a steering column assembly in a coupled condition according to another aspect of the disclosure; and

FIG. 4 is a partial cross-sectional view of the steering column assembly of FIG. 3 in a decoupled condition.

### DETAILED DESCRIPTION

Referring now to the Figures, where the invention will be described with reference to specific embodiments, without limiting same, various features of a steering column assembly for an autonomous vehicle are illustrated. As described herein, the embodiments provide a reliable and efficient assembly that allows a driver to decouple a steering wheel from a lower steering shaft for use of the vehicle in an autonomous mode, while maintaining the steering wheel in a stationary position.

The steering column assembly is part of an advanced driver assist system (ADAS) that is able to steer as well as control other parameters of the vehicle to operate it without direct driver involvement. Autonomous or semi-autonomous driving refers to vehicles that are configured to perform operations without continuous input from a driver (e.g., steering, accelerating, braking etc.) and may be equipped with technology that allows the vehicle to be autonomously or semi-autonomously controlled using sensing, steering, and/or braking technology.

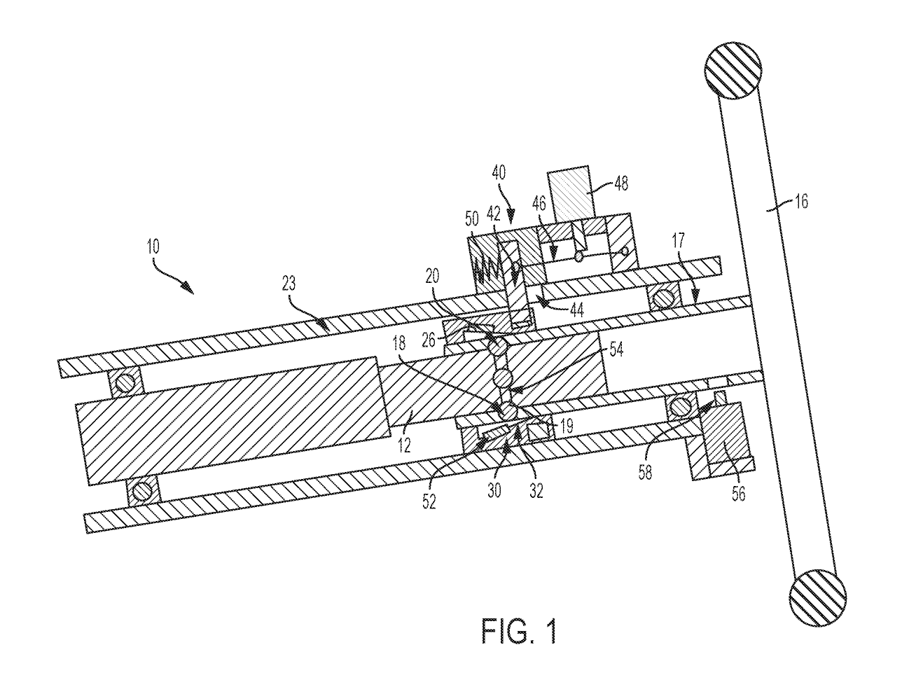

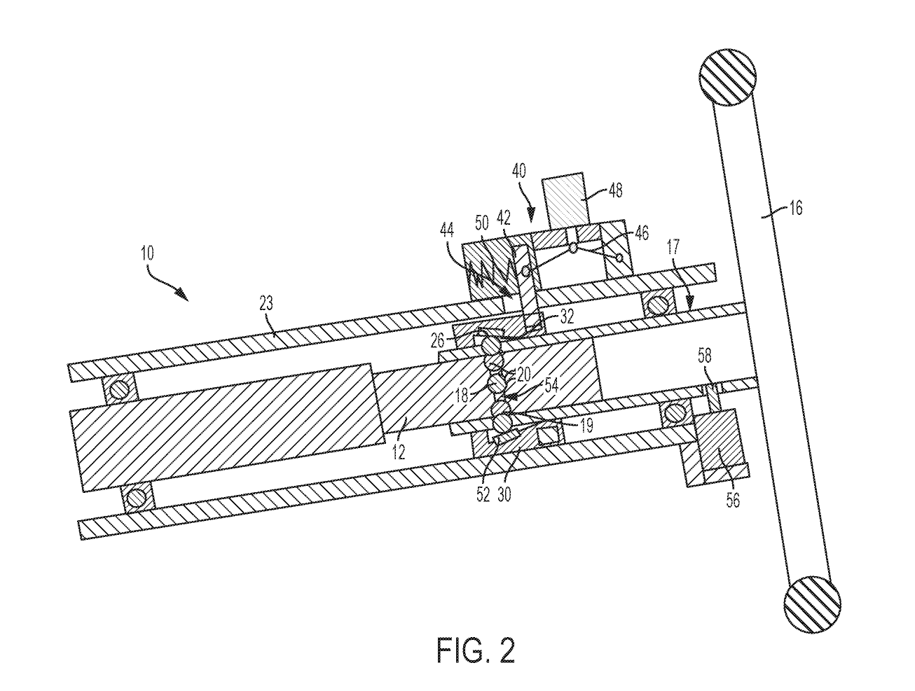

Referring to FIGS. 1 and 2, a portion of a steering column assembly 10 is shown according to an embodiment. The steering column assembly 10 includes a lower column steering shaft 12 (also referred to herein as a lower steering shaft) that is operatively coupled to road wheel control structures (not shown), thereby allowing a driver to input road wheel controls and to receive feedback in response to road wheel movement. A column jacket surrounds a portion of the lower steering shaft 12. A steering input device, such as the illustrated steering wheel 16, is operatively coupled to the lower steering shaft 12 via an upper column steering shaft 17 (also referred to herein as an upper steering shaft) to allow the user to control the vehicle in a manual driving mode. The upper steering shaft 17 is rigidly fixed to the steering wheel 16 with a splined connection, or the like, to ensure common rotation of the steering wheel 16 and the upper steering shaft 17.

The steering column assembly 10 is shown in the manual driving mode in FIG. 1. In the manual driving mode, the upper steering shaft 17 is coupled to the lower steering shaft 12, also referred to as being rotationally coupled. The coupled (or rotationally coupled) condition of the upper steering shaft 17 and the lower steering shaft 12 results in common rotation of the steering wheel 16 and the lower steering shaft 12, such that rotation of the components is dependent upon each other. Conversely, a decoupled condition (FIG. 2) of the upper steering shaft 17 and the lower steering shaft 12 may be present during an autonomous driving mode. The decoupled (or rotationally decoupled) condition results in independent rotation of the steering wheel 16 and the lower steering shaft 12, such that rotation of the lower steering shaft 12 in response to road wheel angular movement does not require or result in rotation of the steering wheel 16. The steering column assembly 10 disclosed herein provides a driver the ability to switch between the coupled and decoupled condition in conjunction with switching between manual and autonomous driving modes.

In contrast to a continuously fixed relationship between the lower steering shaft 12 and the steering wheel 16 that is achieved with a splined mating assembly, the embodiments described herein employ at least one, but typically a plurality of balls 18 to establish the coupled or decoupled conditions. The plurality of balls 18 are part of a ball coupling assembly and are fixed within a ball retaining structure, such as a plurality of respective holes 19, defined by the upper steering shaft 17 in a one-to-one relationship. The holes 19 are circumferentially spaced from each other and are each sized to axially and circumferentially retain one of the balls 18 therein.

The lower steering shaft 12 defines a plurality of pockets 20 disposed in a common axial plane and that are circumferentially spaced from each other. The plurality of pockets 20 extend to a radial depth of the lower steering shaft 12 that allows the balls to be partially disposed therein, but with a portion of the balls 18 protruding radially outwardly therefrom. The balls 18 are positioned within the pockets 20 in the coupled condition of the lower steering shaft 12 with the upper steering shaft 17 and the steering wheel 16. The balls protrude radially from the pockets 20 to engage both the pocket surfaces and the walls defining the holes 19 of the upper steering shaft 17. Therefore, when the balls 18 are positioned with the pockets 20 of the lower steering shaft 12, torque transmission between the steering wheel 16 and the lower steering shaft 12 is established.

To retain the balls 18 within the pockets 20 and prevent radial movement of the balls 18, an inner wall 26 of a collar 30 is disposed in contact with the balls 18. More specifically, an innermost location of an angled portion 32 of the inner wall 26 is in contact with the balls 18. The collar 30 is disposed between the upper steering shaft 17 and a column housing structure 23. Due to the angled portion 32 of the inner wall 26, a portion of the inner wall 26 is spaced from the balls 18 to allow the balls 18 to move radially outwardly in some conditions, as described in detail herein.

A collar actuating mechanism 40 is provided to selectively axially translate the collar 30 in order to control the portion of the angled portion 32 that is adjacent the balls 18, as this positioning determines whether the balls 18 are radially retained within the pockets 20 or free to move radially outwardly. A driving structure 42, such as a pin or shift fork is engaged with the collar 30. The driving structure 42 extends through an aperture 44 of the column housing structure 23 in the illustrated embodiment. The aperture 44 is large enough to accommodate axial travel by the driving structure 42. A linkage 46 is coupled to the driving structure 42 at one end and to the column housing structure 23 at an opposing end. Different positioning of the linkage 46 axially translates the driving structure 42 and therefore the collar 30 between two axial positions. Manipulation of the linkage 46 may be accomplished with any suitable actuator, such as an electric solenoid 48 having a pin engageable with the linkage 46.

In a first state (i.e., powered or unpowered) of the electric solenoid 48, the linkage 46 positions the driving structure 42, and therefore the collar 30, in an orientation that disposes the balls 18 in the pockets 20. This provides the coupled condition (FIG. 1), with the innermost location of the angled portion 32 in contact with, or in close proximity to, the balls 18 to radially retain the balls 18 within the pockets 20. In second state (i.e., powered or unpowered) of the electric solenoid 48, the driving structure 42 is biased with a spring 50 to move the collar 30 to a position that locates a radially outer region of the angled portion 32, thereby allowing the balls 18 to move radially outwardly. Outward radial movement of the balls 18 is facilitated with one or more magnets 52 located on or in the collar 30 in some embodiments. The lower steering shaft 12 defines an annular recess 54 that is located at the same axial position as the pockets 20, but the annular recess 54 extends to a radial depth that is less than the radial depth of the pockets 20. This provides a continuous track for the balls to travel through when the balls 18 are at the outer radial position (i.e., decoupled condition), thereby rotationally decoupling the steering wheel from the lower steering shaft 12.

The steering column assembly 10 also facilitates autonomous mode for the steering wheel 16 when the assembly in the decoupled condition. An autonomous mode refers to a rotationally stationary position and condition of the steering wheel 16. Maintaining the steering wheel 16 in a stationary position reduces the likelihood of driver confusion, inconvenience and/or harm.

Placing the steering wheel in the stationary position occurs upon transition to the decoupled condition of the steering column assembly 10 shown in FIG. 2. In the illustrated embodiment, an electric solenoid 56 includes a pin 58 extending therefrom. The electric solenoid 56 is switchable between a first state (i.e., powered or unpowered) and a second state (i.e., powered or unpowered), with one state disposing the pin 58 in a retracted position (FIG. 1) and the other state disposing the pin 58 in an extended position (FIG. 2). The extended position of the pin 58 engages the pin 58 with a receiving hole 60 defined by the upper steering shaft 17 to rotationally lock the steering wheel 16 when the upper and lower steering shafts 12, 17 are in the decoupled condition. The preceding example is merely illustrative of how the steering wheel 16 may be locked in the “quiet wheel” mode. Although the steering wheel 16 is rotationally locked, the lower steering shaft 12 is free to rotate due to the balls 18 being disposed in the outward radial position.

In operation, a user interacts with a user input device that switches the states of both electric solenoids 48, 56. The user input device may be a button, toggle switch, voice activated command, etc. These types of input devices are merely illustrative of the devices that may be employed to switch the states of the solenoids.

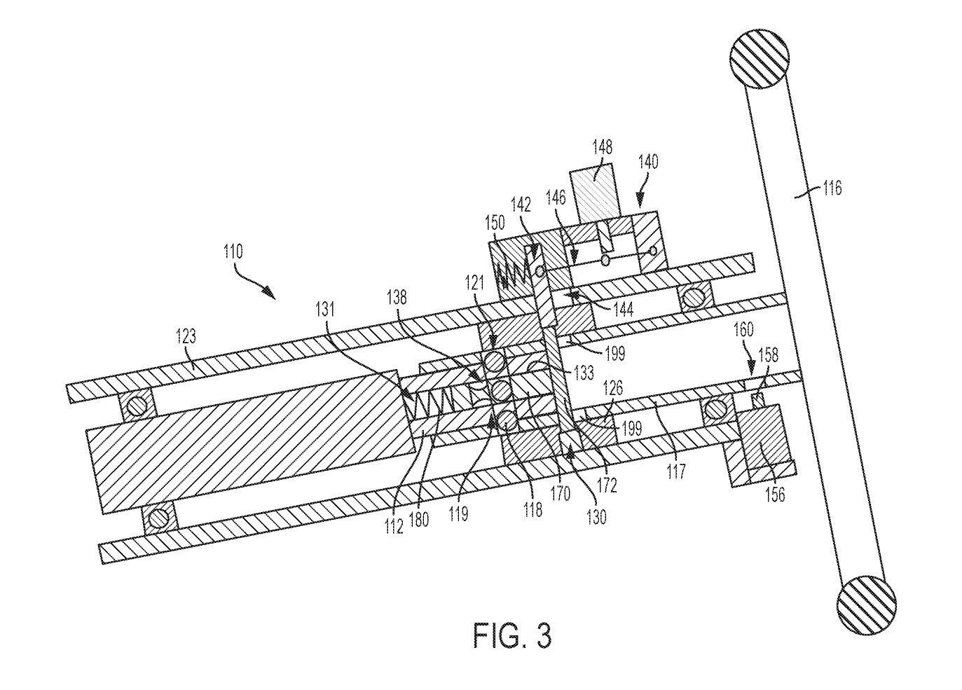

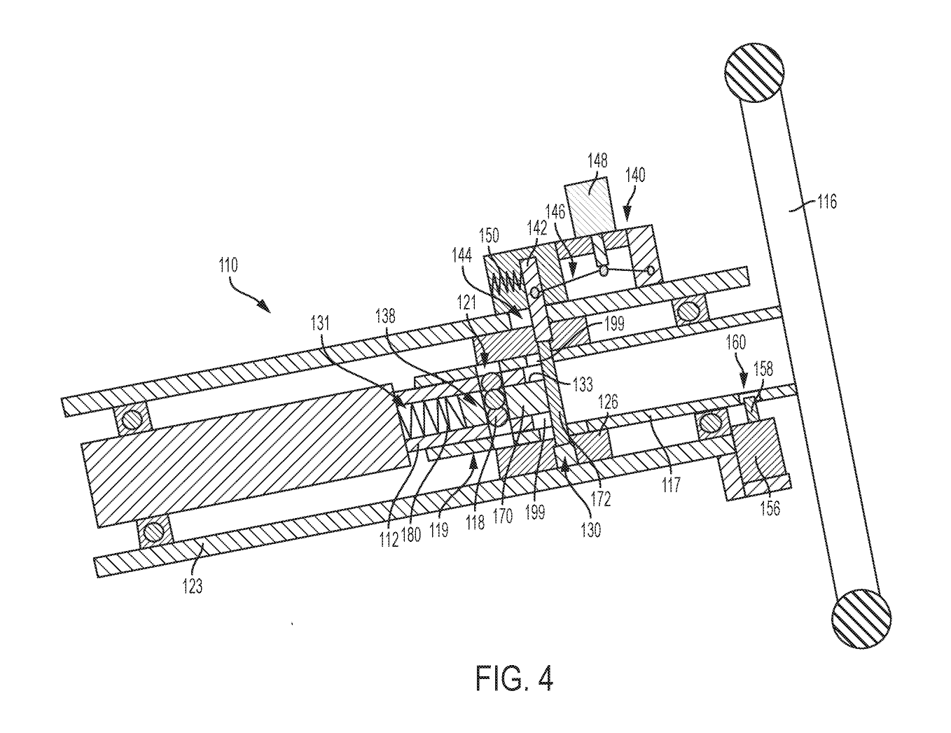

Referring now to FIGS. 3 and 4, another aspect of the disclosure is illustrated. In particular, a portion of a steering column assembly 110 is shown according to an embodiment. The steering column assembly 110 includes a lower column steering shaft 112 (also referred to herein as a lower steering shaft) that is operatively coupled to road wheel control structures (not shown), thereby allowing a driver to input road wheel controls and to receive feedback in response to road wheel movement. A column jacket surrounds a portion of the lower steering shaft 112. A steering input device, such as the illustrated steering wheel 116, is operatively coupled to the lower steering shaft 112 via an upper column steering shaft 117 (also referred to herein as an upper steering shaft) to allow the user to control the vehicle in a manual driving mode. The upper steering shaft 117 is rigidly fixed to the steering wheel 116 with a splined connection, or the like, to ensure common rotation of the steering wheel 116 and the upper steering shaft 117.

The steering column assembly 110 is shown in the manual driving mode in FIG. 3. In the manual driving mode, the upper steering shaft 117 is coupled to the lower steering shaft 112, also referred to as being rotationally coupled. The coupled (or rotationally coupled) condition of the upper steering shaft 117 and the lower steering shaft 112 results in common rotation of the steering wheel 116 and the lower steering shaft 112, such that rotation of the components is dependent upon each other. Conversely, a decoupled condition (FIG. 4) of the upper steering shaft 117 and the lower steering shaft 112 may be present during an autonomous driving mode. The decoupled (or rotationally decoupled) condition results in independent rotation of the steering wheel 116 and the lower steering shaft 112, such that rotation of the lower steering shaft 112 in response to road wheel angular movement does not require or result in rotation of the steering wheel 116. The steering column assembly 110 disclosed herein provides a driver the ability to switch between the coupled and decoupled condition in conjunction with switching between manual and autonomous driving modes.

In contrast to a continuously fixed relationship between the lower steering shaft 112 and the steering wheel 116 that is achieved with a splined mating assembly, the embodiments described herein employ at least one, but typically a plurality of balls 118 to establish the coupled or decoupled conditions. The plurality of balls 118 are part of a ball coupling assembly and are fixed within ball retaining structure, such as a plurality of respective holes 119 defined by the lower steering shaft 112 in a one-to-one relationship. The holes 119 are circumferentially spaced from each other and are each sized to axially and circumferentially retain one of the balls 118 therein. The upper steering shaft 117 also has a plurality of holes 121 that are circumferentially spaced from each other and are each sized to axially and circumferentially retain a portion of one of the balls 118 therein. The holes 121 of the upper steering shaft 117 and the holes 119 of the lower steering shaft 112 are equal in number and aligned in a common axial plane.

A central pin 170 is disposed within an axially extending bore 131 of the lower steering shaft 112. The central pin 170 includes a grooved surface leading from a radially outer surface 133 of the central pin 170 to an annular recess 138 defined by the central pin 170. In the coupled condition shown in FIG. 3, the balls 118 are in abutment with the radially outer surface 133 of the central pin 170. The balls 118 protrude radially to engage the walls defining the holes 119 of the lower steering shaft 112 and the holes 121 of the upper steering shaft 117. Therefore, when the balls 118 are positioned as such, torque transmission between the steering wheel 116 and the lower steering shaft 112 is established.

To radially retain the balls 118, an inner wall 126 of a collar 130 is disposed in contact with an outer radial surface of the balls 118. The collar 130 is disposed between the upper steering shaft 117 and a column housing structure 123. The collar 130 is operatively coupled to the central pin 170 and the elements are axially translatable in a dependent manner. Operative coupling of the collar 130 and the central pin 170 may be achieved with a pin 172 that is disposed in forced contact with the central pin 170 and the collar 130 as a result of a preload reaction of spring 150 against driving pin 142. The spring 150 is provided in some embodiments, but is not necessary to bias the driving pin 142 in some embodiments. In some embodiments, it is contemplated that the pin 172 and the central pin 170 are fixed to each other. The pin 172 extends through and axially moves within slots 199 defined by the upper steering shaft 117.

A collar actuating mechanism 140 is provided to axially translate the collar 130 in order to control the axial position of the central pin 170, as this positioning determines whether the balls 118 are located at a first radial position or a second radial position. In particular, the balls 118 may be located at a first radial position when the balls 118 are disposed radially inwardly within the annular recess 138 and at a second radial position when the balls 118 are disposed in abutment with the radially outer surface 133 of the central pin 170. The radial position of the balls 118 is dependent upon the axial position of the central pin 170.

The collar actuating mechanism 140 includes a driving structure 142, such as a pin or shift fork is engaged with the collar 130. The driving structure 142 extends through an aperture 144 of the column housing structure 123 in the illustrated embodiment. The aperture 144 is large enough to accommodate axial travel by the driving structure 142. A linkage 146 is coupled to the driving structure 142 at one end and to the column housing structure 123 at an opposing end. Different positioning of the linkage 146 axially translates the driving structure 142 and therefore the collar 130 between two axial positions. Manipulation of the linkage 146 may be accomplished with any suitable actuator, such as an electric solenoid 148 having a pin engageable with the linkage 146.

In a first state (i.e., powered or unpowered) of the electric solenoid 148, the linkage 146 positions the driving structure 142, and therefore the collar 130, in an orientation that disposes the balls 118 in abutment with the radially outer surface 133 of the central pin 170. This provides the coupled condition (FIG. 3. In a second state (i.e., powered or unpowered) of the electric solenoid 148, the driving structure 142 is biased with a spring 150 to move the collar 130 to a position that moves the balls 118 radially inwardly and out of contact with the wall defining the holes 121 of the upper steering shaft 117. In this position, the balls 118 are located within the annular recess 138 which provides a continuous track for the balls 118 to travel through when the balls 118 are at the inner radial position (i.e., decoupled condition), thereby rotationally decoupling the steering wheel 116 from the lower steering shaft 112. A spring 180 located within the bore 131 of the lower steering shaft 112 biases the central pin 170 to the axial position that disposes the balls 118 in the annular recess 138.

The steering column assembly 10 is also facilitates a rotationally stationary position and condition of the steering wheel 116. Maintaining the steering wheel 116 in a stationary position reduces the likelihood of driver confusion, inconvenience and/or harm.

Placing the steering wheel 116 in the stationary position occurs upon transition to the decoupled condition of the steering column assembly 110 shown in FIG. 4. In the illustrated embodiment, an electric solenoid 156 includes a pin 158 extending therefrom. The electric solenoid 156 is switchable between a first state (i.e., powered or unpowered) and a second state (i.e., powered or unpowered), with one state disposing the pin 158 in a retracted position (FIG. 3) and the other state disposing the pin 158 in an extended position (FIG. 4). The extended position of the pin 158 engages the pin 158 with a receiving hole 160 defined by the upper steering shaft 117 to rotationally lock the steering wheel 116 when the upper and lower steering shafts 112, 117 are in the decoupled condition. The preceding example is merely illustrative of how the steering wheel 116 may be locked in the “quiet wheel” mode. Although the steering wheel 116 is rotationally locked, the lower steering shaft 112 is free to rotate due to the balls 118 being disposed in the inward radial position.

In operation, a user interacts with a user input device that switches the states of both electric solenoids 148, 156. The user input device may be a button, toggle switch, voice activated command, etc. These types of input devices are merely illustrative of the devices that may be employed to switch the states of the solenoids.

In some of the above-described embodiments, the overall steering system is monitored with an absolute position sensor and the system only allows switching between the driving modes (autonomous and manual) when the steering system is in an “on-center position” (e.g., straight ahead driving position). This facilitates a smooth transition between the driving modes.

The embodiments described herein provide a reliable and efficient way to transition between the coupled and decoupled conditions of the steering column assembly 10. Additionally, the steering wheel 16 is desirably maintained in a stationary position (rotationally) while the assembly is in the decoupled condition and autonomous driving mode.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering column assembly for an autonomous or semi-autonomous vehicle having a steering wheel, the assembly comprising:
an upper column steering shaft rigidly coupled to the steering wheel;
a lower column steering shaft operatively coupled to the upper column steering shaft; and
a ball coupling assembly for switching the upper column steering shaft and the lower column steering shaft between a coupled condition and a decoupled condition, the ball coupling assembly comprising:
a plurality of balls retained within the upper column steering shaft;
a plurality of pockets circumferentially spaced from each other and defined by the lower steering shaft, each of the pockets sized to receive a portion of one of the plurality of balls;
a collar surrounding the balls, the collar having an angled portion of an inner wall disposed in contact with the balls; and
a collar actuating mechanism for selectively axially translating the collar between a coupled condition and a decoupled condition.

2. The steering column assembly of claim 1, wherein the balls are disposed at a first radial position that disposes the balls within the pockets to place the upper and lower column steering shafts in the coupled condition, the balls disposed at a second radial position that removes the balls from the pockets to place the upper and lower column steering shafts in the decoupled condition, the coupled condition providing common rotation of the upper and lower column steering shafts and the decoupled condition permitting independent rotation of the upper and lower column steering shafts, the steering column assembly further comprising an annular recess defined by the lower column steering shaft, the annular recess extending to a radial depth that is less than a radial depth of the plurality of pockets, the balls free to rotate along the annular recess when the balls are in the second radial position.

3. The steering column assembly of claim 1, wherein the collar actuating mechanism further comprises:
a driving structure engaged with the collar; and
a linkage coupled to the driving structure to axially translate the collar.

4. The steering column assembly of claim 3, wherein the linkage is secured to a column housing structure of the steering column assembly.

5. The steering column assembly of claim 2, wherein the collar actuating mechanism further comprises an actuator engaged with the linkage to actuate movement of the linkage.

6. The steering column assembly of claim 5, wherein the actuator comprises an electric solenoid biasing the linkage in a first state of the solenoid to position the balls in the first radial position, the electric solenoid switchable to a second state to allow the balls to move to the second radial position.

7. The steering column assembly of claim 6, wherein the collar actuating mechanism further comprises a spring axially biasing the driving structure to position the balls in the second radial position when the electric solenoid is in the second state.

8. The steering column assembly of claim 2, wherein the collar includes a magnet located proximate the inner wall to attract the balls radially outwardly to the second radial position.

9. The steering column assembly of claim 1, further comprising an electric solenoid having a pin extending therefrom, the pin engageable with a receiving hole defined by the upper column steering shaft to rotationally lock the steering wheel when the upper and lower column steering shafts are in the decoupled condition.

10. The steering column assembly of claim 1, wherein the upper and lower steering column shafts are switched between the coupled condition and the decoupled condition with a user input device.

11. The steering column assembly of claim 10, wherein the user input device comprises one of a button, a switch and a voice prompt system.

12. A steering column assembly for an autonomous or semi-autonomous vehicle having a steering wheel, the assembly comprising:
an upper column steering shaft rigidly coupled to the steering wheel;
a lower column steering shaft operatively coupled to the upper column steering shaft; and
a ball coupling assembly for switching the upper column steering shaft and the lower column steering shaft between a coupled condition and a decoupled condition, the ball coupling assembly comprising:
a plurality of balls retained within respective holes defined by the lower column steering shaft in a single axial plane;
a central pin disposed within a bore of the lower column steering shaft and axially translatable therein;
an annular recess defined by the central pin; and
a central pin actuating mechanism for axially translating the central pin, the balls disposed at a first radial position that disposes the balls within the annular recess to place the upper and lower column steering shafts in a decoupled condition, the balls disposed at a second radial position that disposes the balls in abutment with a radially outer surface of the central pin and within the holes of the lower column steering shaft and holes of the upper column steering shaft to place the upper and lower column steering shafts in a coupled condition, the coupled condition providing common rotation of the upper and lower column steering shafts and the decoupled condition permitting independent rotation of the upper and lower column steering shafts.

13. The steering column assembly of claim 12, wherein the central pin actuating mechanism further comprises:
a collar disposed between the upper column steering shaft and a column housing structure and operatively coupled to the central pin;
a driving structure engaged with the collar; and
a linkage coupled to the driving structure to axially translate the collar and the central pin.

14. The steering column assembly of claim 13, wherein the linkage is secured to the column housing structure of the steering column assembly.

15. The steering column assembly of claim 13, wherein the collar actuating mechanism further comprises an actuator engaged with the linkage to actuate movement of the linkage.

16. The steering column assembly of claim 15, wherein the actuator comprises an electric solenoid biasing the linkage in an first state of the solenoid to position the balls in the first radial position, the electric solenoid switchable to a second state to allow the balls to move to the second radial position, the upper and lower steering column shafts switchable between the coupled condition and the decoupled condition with a user input device comprising one of a button, a switch and a voice prompt system.

17. The steering column assembly of claim 16, wherein the collar actuating mechanism further comprises a spring axially biasing the driving structure to position the balls in the first radial position when the electric solenoid is in the first state.

18. The steering column assembly of claim 12, further comprising an electric solenoid having a pin extending therefrom, the pin engageable with a receiving hole defined by the upper column steering shaft to rotationally lock the steering wheel when the upper and lower column steering shafts are in the decoupled condition.

19. A steering column assembly for an autonomous or semi-autonomous vehicle having a steering wheel, the assembly comprising:
an upper column steering shaft rigidly coupled to the steering wheel;
a lower column steering shaft operatively coupled to the upper column steering shaft; and
a ball coupling assembly comprising a plurality of balls retained within the upper column steering shaft, the balls disposed in a first radial position that engages the balls with the upper column steering shaft and the lower column steering shaft to place the upper and lower column steering shafts in a coupled condition, the balls disposed in a second radial position that disengages the balls from at least one of the upper column steering shaft and the lower column steering shaft to place the upper and lower column steering shafts in a decoupled condition.
